(19) United States
(12) Patent Application Publication
(10) Pub. No.: US 2026/0043103 A1
(43) Pub. Date: Feb. 12, 2026

(54) OPTIMIZED MELTING OF COMPACTED DRI

(71) Applicant: PRIMETALS TECHNOLOGIES AUSTRIA GMBH, Linz (AT)

(72) Inventors: Robert MILLNER, Loosdorf (AT); Jan-Friedemann PLAUL, Linz (AT)

(73) Assignee: PRIMETALS TECHNOLOGIES AUSTRIA GMBH, Linz (AT)

(21) Appl. No.: 19/140,257

(22) PCT Filed: Dec. 13, 2023
(86) PCT No.: PCT/EP2023/085655

§ 371 Date: Jun. 17, 2025

(30) Foreign Application Priority Data
Dec. 21, 2022 (EP) 22215246.4
Apr. 25, 2023 (EP) 23169795.4

(51) Int. Cl. C21B 13/00; C21B 13/14; C21C 5/52

(52) U.S. Cl. CPC C21B 13/0086; C21B 13/143; C21C 5/527

(57) ABSTRACT

A method for melting DRI consisting at least partly of HBI and/or HCI using a melting process, wherein the HBI and/or the HCI is comminuted before being supplied to the melting process, and HBI or HCI fragments obtained during the comminuting process are supplied to the melting process.

### CROSS-REFERENCE TO RELATED APPLICATIONS

The present application is a national phase application of PCT Application No. PCT/EP2023/085655, filed Dec. 13, 2023, entitled “OPTIMIZED MELTING OF COMPACTED DRI”, which claims the benefit of European Patent Application No. 22215246.4, filed Dec. 21, 2022, and European Patent Application No. 23169795.4, filed Apr. 25, 2023, each of which is incorporated by reference in its entirety.

### BACKGROUND OF THE INVENTION

### 1. Field of the Invention

The application relates to a method for melting DRI consisting at least partly of HBI and/or HCI by means of a melting process.

### 2. Description of the Related Art

The reduction of materials containing iron oxide by direct reduction with a reducing gas in a reduction unit—for example in a fixed bed or a fluid or fluidized bed—at elevated temperature is known. The solid product of direct reduction is known as sponge iron, or direct reduced iron (DRI): it is very porous and accordingly very reactive, for example toward oxidation. In the course of its further processing, DRI is usually melted.

In order to reduce reactivity and thus simplify further processing, DRI is often compacted in a hot state, i.e. as hot sponge iron, or hot direct reduced iron (HDRI). The product of the compaction is hot-briquetted sponge iron, or hot-briquetted iron (HBI), for example when producing briquettes, or hot-compacted sponge iron, or hot-compacted iron (HCI), for example in the case of DRI production in a fluid bed or fluidized bed. Especially in the case of finely particulate HDRI dust, for example from fluidized bed or fluid bed processes, compaction to HBI or HCI helps avoid losses in yield due to dust losses and losses in quality.

The current size of globally available HBI briquettes that are transportable by ship based on an apparent density of greater than 5.0 g/cm³ is 106×48×33 mm; this is the result of endeavors to achieve the best-possible HBI performance with the fewest briquetting machines possible. The apparent density of HCI is lower than that of HBI—typically in the region of 3.5-4.2 g/cm³—and is therefore not suitable for transportation by ship according to the International Maritime Organization (IMO). The size of HCI can also be smaller than that of HBI, for example 50×38×22 mm.

If compacted DRI, for example HBI or HCI, is during its further processing melted in for example an arc furnace, a melting unit or a submerged arc furnace (SAF), the latitude for the rate of addition to a melting process is determined by the time it takes for a briquette to melt therein. This also depends on the energy output that can be supplied to the melting process, which in turn can have an influence on the productivity thereof. By comparison with the melting of DRI, HBI has disadvantages in this regard.

### SUMMARY OF THE INVENTION

A method is to be presented that makes it possible to reduce or avoid at least some of the abovementioned disadvantages when using compacted DRI.

This object is achieved by a method
for melting sponge iron (DRI) consisting at least partly of hot-briquetted sponge iron (HBI) and/or hot-compacted sponge iron (HCI) by means of a melting process,
   wherein the hot-briquetted sponge iron (HBI) and/or hot-compacted sponge iron (HCI) are comminuted prior to supply to the melting process and fragments of the hot-briquetted sponge iron (HBI) and/or hot-compacted sponge iron (HCI) obtained during comminution are supplied to the melting process.

As described in the introduction, DRI can be uncompacted or compacted. HBI and HCI are specific cases of the general term DRI; they refer to compacted DRI.

If the temperature of the DRI undergoing briquetting is above 650° C., the product of DRI compaction is referred to as hot-briquetted sponge iron or hot-briquetted iron (HBI) when its apparent density is above 5.0 g/cm³. For compacted DRI that does not fully meet these criteria, i.e. when the apparent density is less than or equal to 5.0 g/cm³ and/or the temperature of the DRI undergoing briquetting is 650° C. or less, the term hot-compacted iron sponge, or hot-compacted iron (HCI), is commonplace.

HBI and HCI are to be understood in the context of the present application as being as defined above.

Information on HBI can be found for example in HOT BRIQUETTED IRON (HBI) QUALITY ASSESSMENT GUIDE, International Iron Metallics Association August 2018, and in current International Maritime Organization IMO regulations.

The melting process preferably takes place using electrical energy.

Comminution results in fragments that are smaller than the HBI or HCI from which they are formed. Fragments take less time to melt. Accordingly, the method of the invention permits a higher rate of addition to a melting process than when HBI or HCI are supplied thereto without the comminution of the invention. To increase the rate of addition, it is therefore not necessary to resort to increasing the energy output supplied to the melting process as has been the practice up to now, which can have an unfavorable effect on productivity. Disadvantages by comparison with melting of uncompacted DRI are thus at least reduced.

It is preferable when the comminution is a crushing operation; this is effected in comminution machines such as crushers and preferably takes place in at least two stages.

A crushing operation yields pieces in the form of fragments of HBI or HCI.

A crushing operation is executed by means of crushers and can employ a single crusher or a crusher system with multiple crushers arranged for example in two or more successive stages, wherein a downstream stage is supplied with the fragments or pieces generated in the previous stage as the input material for the comminution taking place therein. A crushing operation that takes place by means of two or more successive stages is a multistage process.

A crushing operation is used for the comminution of solid material, comminution being achieved by crushing said material through crushing processes in comminution machines such as crushers.

The material is preferably comminuted to a size of fragment—also termed particle size—within a range of from 3.35 mm to 31.5 mm, preferably from 3.35 mm to 25 mm, particularly preferably from 6.3 mm to 16 mm. The ranges here are inclusive of the respective limits. The upper limit for the size of fragment preferably obtained in the comminution is preferably 31.5 mm, more preferably 25 mm, very particularly preferably 16 mm. The lower limit for the size of fragment preferably obtained in the comminution is preferably 3.35 mm, particularly preferably 6.3 mm.

This size has been found to be favorable with regard to the effects during melting that are the aim of the invention.

The above particle sizes refer to US standard ASTM E11.

In the process of comminution to a particle size in accordance with the abovementioned range of 3.35 to 31.5 mm or preferred and particularly preferred subranges thereof, in practice some smaller fragments and sometimes also some larger fragments will also be obtained.

According to one embodiment, fragments obtained during comminution are supplied to the melting process irrespective of whether or not they are actually within the abovementioned range of 3.35 to 31.5 mm/within the preferred and particularly preferred subranges thereof. The melting process is thus supplied not just with fragments having a particle size within the abovementioned range of 3.35 to 31.5 mm/within the preferred and particularly preferred subranges thereof, but also with fragments lying outside this range or subranges.

According to another embodiment, which will be explained more particularly below, a minimum size is defined for the fragments formed during comminution, and fragments formed during comminution that are below the minimum size are removed, and only fragments above the minimum size are supplied to the melting process.

According to one embodiment, fragments obtained during comminution are supplied to the melting process only if they are actually within the abovementioned range of 3.35 to 31.5 mm/within the preferred and particularly preferred subranges thereof.

It is preferable when the DRI consists entirely of HBI and/or HCI.

According to a preferred embodiment, the melting process comprises at least one of the group of methods consisting of
melting in an electric arc furnace (EAF),
melting in a submerged arc furnace (SAF),
melting in an open slag bath furnace (OSBF),
melting in a melting unit,
melting in a converter vessel.

In a melting unit, melting is at least partially on the basis of electrical energy.

EAF, SAF, and OSBF are not to be understood as melting units in the context of this application.

A converter vessel is for example a steelmaking converter for steel production.

According to one embodiment, a minimum size is defined for the fragments formed during comminution, and fragments formed during comminution that are below the minimum size are removed.

Removal is for example by sieving.

The fragments below the minimum size can be supplied to a process for producing HBI or HCI, for example by means of bucket elevators or pneumatic conveying, in order to undergo compaction there together with HDRI.

Fragments above the minimum size are supplied at least in part to the melting process.

### BRIEF DESCRIPTION OF THE DRAWINGS

The above-described properties, features, and advantages of this invention and the manner in which they are achieved will become clearer and more clearly comprehensible in conjunction with the following description of embodiments, which are elucidated more particularly in conjunction with the schematic and exemplary drawings. In the figures:

FIG. 1 illustrates schematically the execution of an embodiment of the method of the invention with HBI.

FIG. 2 illustrates schematically the execution of an embodiment of the method of the invention with HCI.

### DETAILED DESCRIPTION

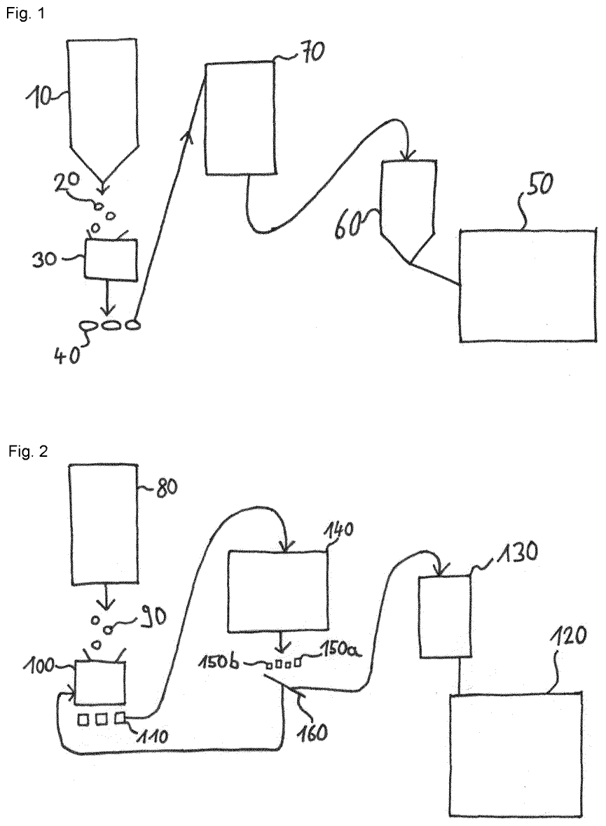

FIG. 1 shows how DRI 20, in the present case HDRI, produced in a reduction unit 10 based on direct reduction in a fixed bed or fluid bed or fluidized bed is compacted into HBI 40 in a briquetting device 30. The HBI is supplied to a melting process in a melting device 50, optionally after transport to another site, for example by rail or by ship. The melting device is for example a device suitable for performing one of the group of methods consisting of
melting in an electric arc furnace (EAF),
melting in a submerged arc furnace (SAF),
melting in an open slag bath furnace (OSBF),
melting in a melting unit
melting in a converter vessel.

Upstream of the supply, which in the example shown takes place via an intermediate bunker 60, but can also take place directly, i.e. without an intermediate bunker, the HBI 40 is crushed in the comminution device 70, which can be single-stage or multistage, for example two-stage. In the example shown, the comminution device is a crusher. Fragments of the HBI 40 obtained during comminution are supplied to the melting device 50 via the intermediate bunker 60.

FIG. 2 shows how DRI 90, in the present case HDRI, produced in a reduction unit 80 based on direct reduction in a fluid bed or fluidized bed is compacted into HCI 110 in a compacting device 100. The HCI 110 is then supplied to a melting process in a melting device 120, where appropriate close to the site of compaction in a plant network. The melting device is for example a device suitable for performing one of the group of methods consisting of
melting in an electric arc furnace (EAF),
melting in a submerged arc furnace (SAF),
melting in an open slag bath furnace (OSBF),
melting in a melting unit,
melting in a converter vessel.

Upstream of the supply, which in the example shown takes place via an intermediate bunker 130, but can also take place directly, i.e. without an intermediate bunker, the HCI 110 is crushed in the comminution device 140, which can be single-stage or multistage, for example two-stage. In the example shown, the comminution device is a crusher. The fragments 150a, 150b of the HCI 110 that are obtained during comminution are sieved in a sieving device 160. Only the fragments 150a above a minimum size are supplied to the melting device 120 via the intermediate bunker 130. The fragments 150b below the minimum size are supplied to the compacting device 100, where they are compacted together with HDRI.

Although the invention has been illustrated and described more particularly by the preferred exemplary embodiments, the invention is not limited by the examples disclosed and other variations can be derived therefrom by a person skilled in the art without departing from the scope of protection of the invention.

### LIST OF REFERENCE NUMERALS

10 Reduction unit
20 DRI
30 Briquetting device
40 HBI
50 Melting device
60 Intermediate bunker
70 Comminution device
80 Reduction unit
90 DRI
100 Compacting device
110 HCI
120 Melting device
130 Intermediate bunker
140 Comminution device
150a,150b Fragments
160 Sieving device

1-5. (canceled)

6. A method for melting sponge iron (DRI) consisting entirely of at least one of hot-briquetted sponge iron (HBI) and hot-compacted sponge iron (HCI), comprising:
comminuting the at least one of the hot-briquetted sponge iron (HBI) and the hot-compacted sponge iron (HCI) prior to being supplied to a melting process;
wherein fragments of the at least one of the hot-briquetted sponge iron (HBI) and the hot-compacted sponge iron (HCI) obtained during comminution are supplied to the melting process.

7. The method as claimed in claim 6, wherein the comminution is a crushing operation.

8. The method as claimed in claim 7, wherein the crushing operation is performed in at least two stages.

9. The method as claimed in claim 6, wherein the comminution is to a size of the fragments within a range of from 3.35 mm to 31.5 mm.

10. The method as claimed in claim 9, wherein the comminution is to the size of the fragments within another range of from 3.35 mm to 25 mm.

11. The method as claimed in claim 10, wherein the comminution is to the size of the fragments within a further range of from 6.3 mm to 16 mm.

12. The method as claimed in claim 6, wherein the melting process comprises at least one of the following methods:
melting in an electric arc furnace (EAF);
melting in a submerged arc furnace (SAF);
melting in an open slag bath furnace (OSBF);
melting in a melting unit; and
melting in a converter vessel.

13. The method as claimed in claim 6, wherein:
a minimum size is defined for the fragments formed during comminution; and
the fragments formed during comminution that are below the minimum size are removed.
